(19) United States
(12) Patent Application Publication
(10) Pub. No.: US 2026/0289957 A1
(43) Pub. Date: Sep. 24, 2026

(54) QUANTIFYING VARIABILITY IN TEXT-TO-IMAGE MODELS

(71) Applicant: Comcast Cable Communications, LLC, Philadelphia, PA (US)

(72) Inventors: Raphael Tang, Washington, DC (US); Lixinyu Xu, Philadelphia, PA (US); Ferhan Ture, Philadelphia, PA (US)

(21) Appl. No.: 19/082,172

(22) Filed: Mar. 18, 2025

(51) Int. Cl. G06V 10/74; G06T 11/00

(52) U.S. Cl. CPC G06V 10/761; G06T 11/00

(57) ABSTRACT

Methods may include causing a first text prompt to be inputted into one or more first models to generate a first image. Methods may include causing the first text prompt to be inputted into the one or more first models to generate a second image. Methods may include determining, based on a comparison of the first image and the second image, a first pairwise distance indicative of a similarity of the first image and the second image. Methods may include determining, based at least on the first pairwise distance, a variability metric indicative of a human-readable characterization of the variability of the first image and the second image.

### BACKGROUND

Diffusion models are the state of the art in text-to-image generation. However, improvements in model output and variability are needed.

### SUMMARY

It is to be understood that both the following general description and the following detailed description are exemplary and explanatory only and are not restrictive.

The systems and methods of the present disclosure relate to understanding and measuring human perception of text-to-image generation. The systems and methods of the present disclosure relate to determining variability of output from text-to-image generation models. As an illustrative example, the systems and methods of the present disclosure relate to conducting a process for constructing a set variability metric. As a further example, a text prompt—used to generate an image—may be used as a parameter to determine the variability metric. The systems and methods of the present disclosure relate to normalization and calibration of data associated with text-to-image generation models into a human-perceptible format.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example environment in which the systems and methods described herein may operate.

FIG. 2 shows example gray-scale images returned based on example prompts.

FIG. 3 shows an illustration of example process described herein.

FIG. 4 shows example gray-scale image pairs, ordered row-wise by calibrated scores.

FIG. 5 shows a visualization of example overlap between the example images were generated for example prompts.

FIG. 6 shows an example plot illustrating reusability of example models.

FIG. 7 shows an example method for quantifying variability in text-to-image models described herein.

FIGS. 8A-8B show an example method for quantifying variability in text-to-image models described herein.

FIG. 9 shows an example method for quantifying variability in text-to-image models described herein.

The accompanying drawings show examples of the disclosure. It is to be understood that the examples shown in the drawings and/or discussed herein are non-exclusive and that there are other examples of how the disclosure may be practiced.

### DETAILED DESCRIPTION

The present disclosure relates to quantifying variability in text-to-image models.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Disclosed herein are systems and methods for examining how prompts affect image variability in black-box diffusion-based models. The disclosure proposes an example variability metric (W1KP), which represents a human-calibrated measure of variability in a set of images. As described herein, the variability metric may be determined from image-pair perceptual distances.

Various examples are presented in the disclosure including three test sets that were curated for evaluation. A perceptual distance created using the systems and methods disclosed herein outperforms nine baselines by up to 18 points in accuracy. Calibration using the systems and methods described herein matches graded human judgements 78% of the time. Using a variability metric (W1KP), prompt reusability was studied and showed that Imagen prompts can be reused for 10-50 random seeds before new images become too similar to already generated images, while Stable Diffusion XL and DALL-E 3 can be reused 50-200 times before new images become too similar to already generated images. Lastly, 56 linguistic features of real prompts were analyzed, finding that the prompt's length, CLIP embedding norm, concreteness, and word senses influence variability most. The present disclosure analyzes diffusion variability from a visuolinguistic perspective.

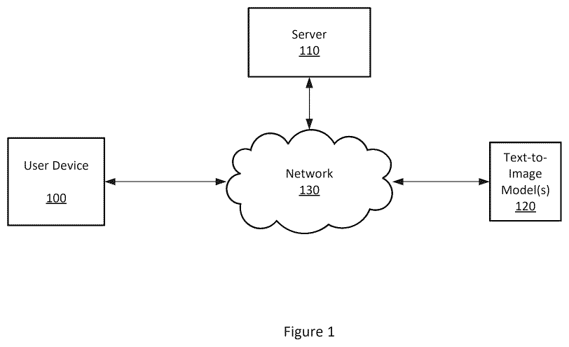

FIG. 1 shows an example environment in which the systems and methods described herein may operate. The environment may comprise a user device 100, a server 110, one or more text-to-image model(s) 120, and a network 130.

The user device 100 may comprise a computing device. The user device 100 may comprise a laptop, smart phone, desktop computer, mainframe, wearing computing device, tablet, etc. The user device 100 may be receive input from a user with an input interface. The input interface may comprise a touchscreen, keyboard, mouse, microphone, touchpad, joystick, etc. The user device 100 may comprise and execute an application. The application may allow the user to enter a prompt. The application may cause communication with the server 110 and/or the one or more text-to-image model(s) 120. The application may cause the prompt to be entered as input into one or more of the one or more text-to-image model(s) 120. The user device 100 may cause the prompt to be transmit to the one or more text-to-image model(s) 120 via the network 130. Although shown as separate, the one or more text-to-image model(s) 120 may reside locally on the user device 100. Although shown as separate, the one or more text-to-image model(s) 120 may reside on the server 110.

The user device 100 may comprise an output interface. The output interface may comprise a display, speakers, a tactile feedback system, etc. The user device 100 may receive an image based on the prompt from the one or more text-to-image model(s) 120. The user device 100 may receive the image based on the prompt from the one or more text-to-image model(s) 120 via the network 130. The output interface may cause the image to be displayed to the user.

The server 110 may comprise one or more computing devices. The server 110 may comprise a cloud computing environment. The server 110 may comprise a variability quantification application. The variability quantification application may quantify prompt reusability for a text-to-image model, such as the one or more text-to-image mode(s) 120, as described below. Although the variability quantification application is described as being disposed in the server 110, the user device 100 may comprise variability quantification application. The server 110 may comprise a first portion of the variability quantification application, and the user device 100 may comprise a second portion of the variability quantification application.

The one or more text-to-image model(s) 120 may receive text (a prompt, words, a phrase, a sentence, etc.) as input and return an image as output. The one or more text-to-image model(s) 120 may comprise a text encode and a denoising image decoder. Text-to-image models, such as the text-to-image model(s) 120, will be discussed in more detail below.

The network 130 may facilitate communication between the user device 100, the server 110, and the one or more text-to-image model(s) 120. The network 130 may comprise a public network, such as the Internet. The network 130 may comprise a private network.

A user may enter a prompt into the user device 100 executing a first application. The first application may cause the prompt to be transmitted to the server 110. A second application executing on the server 110 may cause a first text-to-image model of the one or more text-to-image model(s) 120 to be called a predetermined number of times using the prompt, and resulting in the predetermined number of images being created by the first text-to-image model using the prompt. The second application may receive the predetermined number of images from the first text-to-image model and create pairwise distances associated with the images. The pairwise distances may be created using a machine learning (ML) model. The pairwise distances may be normalized using a normalization function, producing a single score. The single score may be assigned a similarity level.

The present disclosure analyzes how prompts affect perceptual variation in generated imagery across random seeds. Two example prompts (P1 and P2):

### P1:

A matte orange ball in the center against a pure white background.

### P2:

Orange ball against white background.

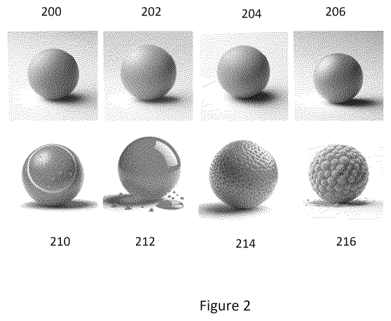

As shown in FIG. 2, the first (resulting in 200, 202, 204, and 206) conveys a single particular illustration, while the second (resulting in 210, 212, 214, and 216) elicits multiple interpretations. Orange could refer to the fruit or the color, and the scene geometry is underspecified. The present disclosure explores how to quantify and characterize linguistic intuitions.

The present disclosure examines the connection between visual variability and language in black-box text-to-image models, focusing on state-of-the-art diffusion models. Previous work tends to study the perceptual distance between pairs of images, while a prompt can generate a near infinite set of images. Furthermore, previous approaches have not been explicitly calibrated for human-friendly grades of similarity. What does a score of, for example, 0.2 mean in terms of perceived similarity? Such calibration is likely helpful for robust human interpretation.

FIG. 2 shows DALL-E 3 images for the prompts “a matte orange ball in the center against a pure white background” (200, 202, 204, and 206) and “orange ball against white background” (210, 212, 214, and 216). The systems and methods described herein may be used to quantify the perceptual similarity for each set of images to a score. The score may be called a W1KP score. The score may yield 0.99 for images 200, 202, 204, and 206. The score may yield 0.68 for images 210, 212, 214, and 216. The scores indicate image variability among images 210, 212, 214, and 216 as greater than image variability among images 200, 202, 204, 206 of the latter.

Systems and methods of the present disclosure relate to a framework for constructing human-calibrated perceptual variability measures based on, for example, perceptual distance metrics. The example framework may be referenced herein as the Words of a Thousand Pictures method (W1KP). On a crowd-sourced dataset of human-judged images from DALL-E 3, Imagen, and Stable Diffusion XL (SDXL), a variant of DreamSim, a recent distance trained on Stable Diffusion images, was validated. The variant of DreamSim chosen outperforms the best baseline by 0.1-0.4 points in two-alternative forced choice and 0.2-0.4 points in accuracy. To improve interpretability, scores were normalized and calibrated to graded human judgements on four levels of perceptual similarity, with cutoff points corresponding to high (0.85-1.0), medium (0.4-0.85), low (0.2-0.4), and no similarity (<0.2), which yield a correct classification 78% of the time.

Practical implications of the systems and methods described herein were investigated. For example, a computer graphics practitioner may wish to generate a diverse array of images from a single prompt, but may be unclear how much the single prompt can be reused with different seeds before additional images contribute little to the variability of the overall set of images. The systems and methods described herein may provide a quantitative metric for prompt reusability. On DiffusionDB, an open dataset of user-written text-to-image prompts, the same prompt can be reused for Imagen for 10-20 random seeds, while SDXL and DALL-E 3 are more reusable at 100-200 seeds.

Fifty-six linguistic features were studied for how the linguistic features affect generation variability. Contributing linguistic constructs in image variability has not previously been explored. To understand the underlying structure of the fifty-six linguistic features, an exploratory factor analysis was performed over DiffusionDB and four factors were discovered (keyword presence (e.g., “dog walking, 4K, watercolor”), syntactic complexity (e.g., Yngve depth), linguistic unit length, and semantic richness). Clean-room, single-word generation experiments were conducted over features in the semantic richness factor (concreteness, CLIP embedding norm, and number of word senses) to assess the contribution of each factor more precisely. All three sematic richness features tested were confirmed to significantly (p<0.01) correlate with perceptual variability for all three diffusion models studied.

The present disclosure proposes and validates a human-calibrated framework for building perceptual variability metrics from existing perceptual distance metrics. The present disclosure examines a new practical application of assessing prompt reusability in text-to-image generation. The present disclosure provides original insight into the linguistic sources of variability in diffusion models, finding that keywords, syntactic complexity, length, and semantic richness influence variability.

Text-to-image diffusion models may be a family of denoising generative models broadly comprising two components: a text encoder that produces latent representations of language, such as T5 or CLIP, and a denoising image decoder that transforms random noise into an image conditioned on text, e.g., a convolutional variational auto-encoder. To generate an image, a prompt may be fed into the text encoder to produce latent representations of language and the latent representations of language may be passed to the image decoder along with randomly sampled noise, then the noise may be iteratively denoised into a meaningful image. Large-scale models may be generally trained using score matching on billions of image-caption pairs, such as the now-deprecated LAION-5B dataset.

The present disclosure explores diffusion in a black-box manner to be able to generalize to proprietary models. Formally, let a text-to-image model be G({wᵢ}; s, θ) whose codomain comprises the sample space of all images [symbol] and domain the sequence of words {wᵢ}, random seed s∈ [symbol] to initialize the image noise, and learned parameters θ∈ [symbol] ^{p}. To generate multiple images from a single prompt, a standard practice is to run multiple trials for different random seeds s, which was implemented.

Three state-of-the-art models were analyzed, one open and two proprietary:

Stable Diffusion XL, an open model which uses CLIP for encoding text and a 2.6 billion-parameter U-Net for generating images.

DALL-E 3, a proprietary API from OpenAI incorporating a pretrained T5-XXL text encoder and the same image decoder architecture as Stable Diffusion XL.

Imagen, a similarly proprietary API from Google using a T5-XXL encoder and an efficient variant of a similar convolutional U-Net decoder.

All three models produce images at least 1024×1024 pixels in resolution.

The present disclosure aims to measure the visual variability of a set of synthetic images. The present disclosure proposes to aggregate perceptual distances, which are well studied in the literature, among all pairs of images in a set. To aid human interpretation of the distances, two steps are applied: first, normalization, which squashes potentially unbounded and “odd” distributions into the standard uniform distribution U[0,1]. For instance, a perceptual distance with a tight range of 5.10-5.19 across 1,000 image sets would be difficult to comprehend. Second, the distances are calibrated to graded human judgements of similarity and corresponding cutoff points are determined, giving meaning to score ranges.

As an illustration, let

$$I := {\{ {I}_{i} \}}_{i = 1}^{n} ⊆ 𝒥$$

be an independent and identically distributed (i.i.d.) sample of images generated by G(⋅). A function η(I) was sought such that η(I′)<η(I) if I′ is more self-similar than I is. A starting point is perceptual distance, a symmetric δ: [symbol] × [symbol] ⁺ that assigns larger values to less similar image pairs. Many metrics embed Iₐ, I_{b}∈ [symbol] using a feature extractor f: [symbol] , then compute a distance d: [symbol] × [symbol] [symbol] ⁺ between f(Iₐ) and f(I_{b}), e.g., Euclidean distance. To standardize the distances to U[0,1] for better interpretability, a cumulative distribution function transform, defined as F(x):= [symbol] (X≤x), was applied. The cumulative distribution function transform has the property of F(X) being uniformly distributed.

If X is a continuous random variable, F(X) is standard uniform U[0,1].

Hence, a normalized d* is

$${d}^{*} ( {I}_{a} , {I}_{b} ) := F ( d ( f ( {I}_{a} ) , f ( {I}_{b} ) ) ) , \qquad ( 1 )$$

and F is estimated from a sample

$${\{ d ( {I}_{{a}_{i}} , {I}_{{b}_{i}} ) \}}_{i = 1}^{m}$$

as \hat{F}(d(Iₐ, I_{b})):=|{d(Iₐ_{ᵢ}, I_{b}_{ᵢ})≤d(Iₐ, I_{b}):1≤I≤m}|/m. As a sample data set, 10,000 image pairs were generated per diffusion model for 1,000 randomly selected DiffusionDB prompts.

Equipped with a uniform perceptual distance, measures of image set variability (η) were constructed. A natural framework for construction of the measures of the image set variability may be used to define a family of U-statistics over sets of images:

Let h: [symbol] × . . . × [symbol] ⁺ be an α-arity kernel parameterized by d. Then a family of U-statistics for measuring image set variability can be defined as

$${U}_{d , h} ( I ) := \frac{1}{( \begin{matrix}n \\ a\end{matrix} )} {\sum }_{1 \leq {i}_{1} < … < {i}_{α} \leq n} h ( f ( {I}_{{i}_{1}} ) , … , f ( {I}_{{i}_{a}} ) ; d ) . \qquad ( 2 )$$

Example values of h may produce estimators of interest. For example:

Pairwise mean (ηₘₑₐₙ): let d=d*, α=2, and h(x, y; d)=d(x, y)—measuring an expected similarity among all pairs of images.

k-expected maximum (ηₖ): let d=d*, α=k, and h(x₁, . . . , x_{α})=min{d(xᵢ, xⱼ):i≠j}-quantifying an expected maximum similarity between a pair of images in a set of size k.

If d is the squared Euclidean distance and h the pairwise mean kernel, U_{d,h} is proportional to the trace of the covariance matrix of f(I₁), . . . , f(Iₙ), i.e., the total variance. Furthermore, to match the convention of scores in [0,1] denoting similarity rather than dissimilarity (e.g., R²), throughout this disclosure, η may be inverted and \tilde{η}:1−η may be reported instead. \tilde{η}:1−η may be referred to as the W1KP score.

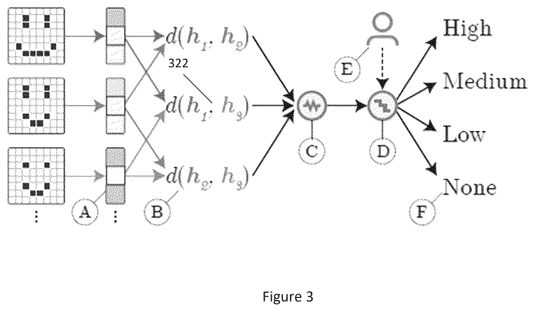

FIG. 3 shows an illustration of W1KP: image embeddings (see A) and pairwise distances (B) computed using a backbone model (perceptual distance backbone model, etc.), fed into a normalization function (C; Eqn. 1) producing a single score in [0,1]. A calibration module (D; Eqn. 3) may align the single score with human judgements (E) then may assign a similarity level (F) between a pair of images.

Lastly, cutoff points for \tilde{η}calibrated to human-judged levels of high, medium, low, and no similarity were found. For human judgement data, a dataset

$${\{ ( {I}_{{x}_{i}} , {I}_{{y}_{i}} , {z}_{i} ) \}}_{i = 1}^{n}$$

was gathered, where Iₓ_{ᵢ}, I_{y}_{ᵢ}∈ [symbol] are a pair of generated images from the same prompt, and zᵢ∈{none, low, mid, high} is the human-annotated level of similarity between Iₓ_{ᵢ} and I_{y}_{ᵢ} (described in more detail below). On the dataset, the cutoff points β_{low}<β_{mid}<β_{high} were chosen to increase label accuracy of splits Sₙₒₙₑ:=[0, β_{low}), S_{low}:=[β_{low}, β_{mid}), S_{mid}:[β_{mid}, β_{high}), S_{high}:[β_{high}, 1.0]:

$$\begin{matrix}arg max \\ {β}_{low} , {β}_{mid} , {β}_{h i g h}\end{matrix} \frac{1}{N} {\sum }_{i = 1}^{N} 𝕀 ( \tilde{η} ( \{ {I}_{{x}_{i}} , {I}_{{y}_{i}} \} ) ∈ {S}_{{z}_{i}} ) , \qquad ( 3 )$$

where [symbol] is the indicator function. FIG. 3 illustrates an overall method described herein.

Before applying W1KP, the quality of the perceptual distance backbone model and interpretability of scores on human judgements may be verified.

### W1KP Quality

| | SDXL | | Imagen | | DALL-E 3 | |
|---|---|---|---|---|---|---|
| Method | 2AFC | Acc. | 2AFC | Acc. | 2AFC | Acc. |
| Oracle | 80.0 | 100 | 80.7 | 100 | 79.3 | 100 |
| L2 | 54.8 | 55.4 | 61.0 | 63.3 | 58.5 | 60.1 |
| SSIM | 55.2 | 56.7 | 59.1 | 61.7 | 57.6 | 59.3 |
| LPIPS | 64.7 | 68.6 | 67.6 | 72.0 | 64.8 | 70.8 |
| ST-LPIPS | 60.0 | 62.4 | 63.4 | 67.6 | 59.6 | 65.4 |
| DISTS | 65.5 | 69.4 | 67.5 | 71.9 | 63.7 | 67.5 |
| SSCD (Large) | 63.4 | 66.7 | 66.0 | 69.1 | 63.3 | 66.7 |
| CoPer (CLIP_{B32}) | 63.2 | 67.8 | 64.4 | 68.9 | 62.4 | 67.9 |
| Raw (CLIP_{L14}) | 67.3 | 72.4 | 70.3 | 76.3 | 67.3 | 75.0 |
| DreamSim (Orig.) | 69.2 | 75.0 | 71.3 | 77.3 | 70.3 | 77.9 |
| DreamSim [symbol] ₂ (Ours) | 69.3 | 75.2 | 71.5 | 77.5 | 70.7 | 78.3 |

Table 1 above shows quality of the backbone models on evaluation sets, across the image generation model.

Following prior work in perceptual distance evaluation, a dataset of two-alternative forced-choice (2AFC) image triplets was crowd-sourced using Amazon MTurk. A process was initiated involving showing five unique workers three generated images from the same prompt—a reference image, image A, and image B—and workers were instructed to pick whether A or B resembled the reference more. The process was repeated three times each for 500 random prompts from DiffusionDB, a large dataset of user-written prompts, for each of SDXL, Imagen, and DALL-E 3, totaling 1,500 triplets per model. Formally, let

$${\{ ( {I}_{{r}_{i}} , {I}_{{a}_{i}} , {I}_{{b}_{i}} , {y}_{{a}_{i}} ) \}}_{i = 1}^{M}$$

be a dataset of M triplets, where Iᵣ_{ᵢ}, Iₐ_{ᵢ}, I_{b}_{ᵢ}∈ [symbol] are images and yₐ_{ᵢ}∈{0, . . . , 5} the number of workers choosing Iₐ_{ᵢ} over I_{b}_{ᵢ}. For non-neural methods, raw-image Euclidean distance (L2) and the structural similarity index were evaluated. For neural backbone models, LPIPS, LPIPS's shift-tolerant variant ST-LPIPS, and an SSIM-inspired variant DISTS were tested, all based on VGG-16; SSCD, a model trained for image copy detection was tested; CoPer, an extension of LPIPS to ViT was tested; raw cosine similarity from CLIP was tested; and lastly, DreamSim, which ensembles pretrained transformers trained on Stable Diffusion images for feature extraction and applies cosine distance for measurement, was tested. Since DreamSim's domain was closest to the systems and methods described herein, DreamSim may be used as a backbone model. A proprietary variant, DreamSimₗ₂, was also evaluated. DreamSimₗ₂ uses L2 instead of cosine distance for d, which benefits from being a true mathematical distance and hence allows for multidimensional scaling analyses.

The standard evaluation metrics of 2AFC score were used, defined as the mean proportion of workers agreeing with the backbone model's scores,

$$i . e . , \frac{1}{M} {\sum }_{i = 0}^{M} 𝕀 ( {I}_{{a}_{i}} {≻}_{r} {I}_{{b}_{i}} ) \frac{{y}_{{a}_{i}}}{5} + 𝕀 ( {I}_{{a}_{i}} {≺}_{r} {I}_{{b}_{i}} ) ( 1 - \frac{{y}_{{a}_{i}}}{5} ) ,$$

where Iₐ_{ᵢ}<ᵣ I_{b}_{ᵢ} if \tilde{η}({Iᵣ_{ᵢ}, Iₐ_{ᵢ}})<\tilde{η}({Iᵣ_{ᵢ}, I_{b}_{ᵢ}}), and majority-vote accuracy. Let \tilde{η}=\tilde{η}ₘₑₐₙ.

Table 1 shows the results. As an upper bound, the maximum possible 2AFC and accuracy are shown in row one. In line with the hypothesis, the DreamSimₗ₂ backbone model attained the highest quality, surpassing CLIP_{L14} raw, the third best, by 2.0 points in 2AFC and 2.8 in accuracy on average. DreamSimₗ₂ slightly outperforms the original DreamSim with statistical significance (p<0.05 on the paired t-test) by 0.1-0.4 in 2AFC and 0.2-0.4 in accuracy, possibly since the embedding norm is informative. Thus, DreamSimₗ₂ was selected as the backbone model for W1KP.

Beyond quality assurance, another purpose the above described evaluation serves may be to ensure that the backbone model does equally well on three models (image generators, etc.). As a sanity check, the oracle (row one) has a spread of 1.4 points (79.3-80.7) in 2AFC on the three models, indicating that humans are unbiased. DreamSimₗ₂ has a spread of 2.2 points (69.3-71.5) in 2AFC, which is below the global average spread of 3.3 points for all the methods. DreamSimₗ₂ exhibits less model-wise bias than its counterparts, possibly due to its increased quality and in-domain training.

A potential issue is that perceptual similarity is inherently subjective and hence challenging to measure. The present disclosure evaluates just-noticeable differences (JND), which is thought to be cognitively impenetrable due to its viewing-time constraint. Because of the high correlation between 2AFC and JND on synthetic images (r=0.94), 2AFC may be implemented as a viable proxy for JND for the present disclosure.

For calibrating W1KP as described above, a crowd-sourced dataset of graded image pairs was collected with MTurk. For 500 random DiffusionDB prompts, three unique workers were presented with a generated pair of images from the same prompt and asked to judge their similarity on a five-point Likert scale ranging from “not similar at all” (rating 1) to “the same” (5). Afterwards, the last two categories (“same” and “very similar”) were merged since the fifth was mostly reserved for attention checks, resulting in the final four categories of high, medium, low, and no similarity. The median across the three judgements was taken and the process was repeated for SDXL, Imagen, and DALL-E 3, for a total of 1,500 median judgements roughly split into 10%, 30%, 40%, and 20% for ratings 1-4. The systems and methods described herein then comprised applying Eqn. (3) with five-fold cross validation.

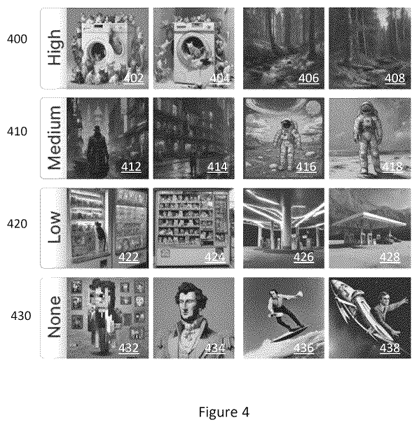

FIG. 4 shows image pairs (in gray-scale) from SDXL, ordered row-wise by calibrated W1KP scores. From top to bottom, the rows 400, 410, 420, and 430 correspond to high (0.85-1.0) (row 400, comprising images 402, 404, 406, and 408), medium (0.4-0.85) (row 410, comprising images 412, 414, 416, and 418), low (0.2-0.4) (row 420, comprising images 422, 424, 426, and 428), and no similarity (0.0-0.2) (row 430, comprising images 432, 434, 436, and 438).

Eqn. (3) yields cutoff points (rounded to the nearest 0.05 for memorability) of 0.2, 0.4, and 0.85 for β_{low}, β_{mid} and β_{high}. Overall, macro- and micro-accuracy scores of 80% and 78% were attained with DreamSimₗ₂ as the backbone model. For comparison, the average macro-/micro-accuracy scores of humans are 82%/80%. DreamSimₗ₂ also outperforms the original DreamSim, which has a macro-/micro-accuracy of 79%/77%. Thus, the calibration described herein yields interpretable cutoffs.

FIG. 4 shows qualitative examples of cutoffs in gray-scale images 402, 404, 406, 408, 412, 414, 416, 418, 422, 424, 426, 428, 432, 434, 436, and 438. The levels appear sensible: “high” pairs (row 400) match in low-level features (e.g., trees in the same location), high-level composition (e.g., cats in washing machine), artistic style (e.g., color photography); medium (row 410) in composition and style; low (row 420) in style; and none (row 430) mostly differing in all. The present disclosure verifies that normalization (Eqn. 1) is useful for the raw scores. Before normalization, raw W1KP scores have 10^{th}, 50^{th}, and 90^{th} percentiles of 0.4, 0.7, and 1.1, significantly deviating from a uniform distribution (p<0.01 according to the KS test).

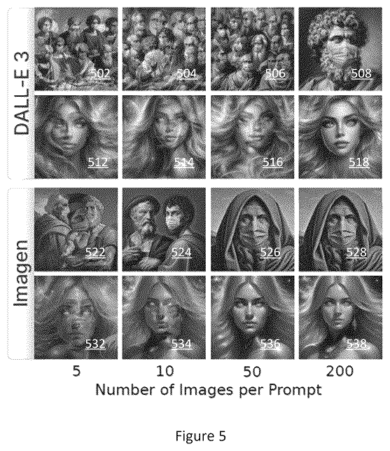

FIG. 5 shows a visualization of the overlap between the two most similar images (on average) as more images were generated for two prompts. The green channel was removed for one image (magenta) and only the green channel was kept for the other, then stack the two. Above, Imagen is reusable up to 10-50 images, while DALL-E 3 up to 50-200. FIG. 5 shows resulting images 502, 504, 506, 508, 512, 514, 516, 518, 522, 524, 526, 528, 532, 534, 536, and 538 in gray-scale. One prompt was used per row of images (a first row comprising images 502, 504, 506, and 508; a second row comprising images 512, 514, 516, and 518; a third row comprising images 522, 524, 526, and 528; and a fourth row comprising images 532, 534, 536, and 538).

Non-normalized scales may be used. As an illustration, normalization scales may score to the 0-1 range, in line with other common statistics such as F₁ score and R². Such a normalized score will have a direct interpretation as the percentile of the raw score on a known ground-truth distribution. Moreover, such normalization and calibration may allow for interpretation of scores to aid human understanding. As an example, below, β_{high} is used as a cutoff for prompt reusability.

With the variability metric established, the present disclosure investigates the connection between visual variability and prompt language for text-to-image models.

The present disclosure considers how many times a prompt can be reused (under different random seeds) until new images are too similar to already generated images. A concern over prompt reusage may apply to graphic asset creation in particular, where visual artists are tasked with rendering many images of the same concept. To study this quantitatively, 50 random prompts were sampled from DiffusionDB, 300 images were generated for each prompt using different seeds on SDXL, Imagen, and DALL-E 3, then the k-expected maximum \tilde{η}ₖ was computed for k=1, . . . , 300.

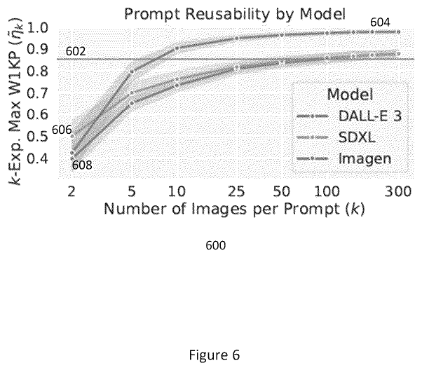

FIG. 6 shows a plot 600 showing k-expected maximum (\tilde{η}ₖ) for k=2 to 300. Shaded regions denote 95% confidence intervals and the red line β_{high}.

As visualized in FIG. 5 and plotted in FIG. 6, diffusion models vary in reusability. DALL-E 3 on average does not generate highly similar images (\tilde{η}ₖ≥β_{high}) until k→200, with an associated visualization (images that were the basis for the gray-scale images 502, 504, 506, 508, 512, 514, 516, and 518 in FIG. 5) displaying much green- and magenta-shifting until the last column. On the other hand, Imagen tends to produce duplicate images for k→50, as shown in images that were the basis for the gray-scale images 522, 524, 526, 528, 532, 534, 536, and 538 in FIG. 5. At 50 images, the two overlaid images are nearly indistinguishable from the true-color image; see the third column. FIG. 6 corroborates the above described visual results shown in FIG. 5, with a horizontal line 602, representing β_{high}, intersecting Imagen's line 604 between 5-10 and DALL-E 3's line 608 at 50-100. FIG. 6 also suggests that SDXL resembles DALL-E 3 in prompt reusability; see the overlap between SDXL's line 606 and DALL-E 3's line 608. The present disclosure concludes that diffusion models differ in prompt reusability, possibly due to different decoder architectures. For example, DALL-E 3 and SDXL share the same U-Net architecture, whereas Imagen's is sparsified.

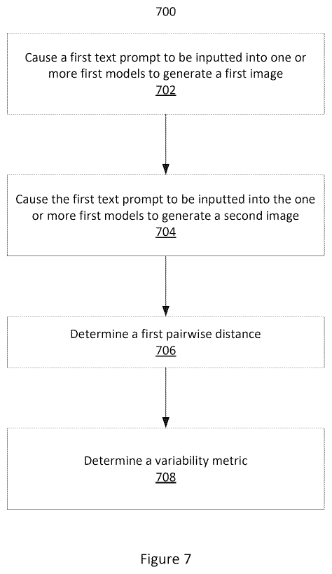

FIG. 7 shows a flowchart of an example process 700. In some implementations, one or more process blocks of FIG. 7 may be performed by the server 110 in FIG. 1 and/or the user device 100 in FIG. 1.

A first text prompt may be caused to be inputted into one or more first models to generate a first image (block 702). The server 110 may cause a first text prompt to be inputted into one or more first models to generate a first image. The user device 100 may cause a first text prompt to be inputted into one or more first models to generate a first image.

The first text prompt may be caused to be inputted into the one or more first models to generate a second image (block 704). The server 110 may cause the first text prompt to be inputted into the one or more first models to generate a second image. The user device 100 may cause the first text prompt to be inputted into the one or more first models to generate a second image.

The first text prompt may be caused to be inputted into the one or more first models to generate a third image. The server 110 may cause the first text prompt to be inputted into the one or more first models to generate a third image. The user device 100 may cause the first text prompt to be inputted into the one or more first models to generate a third image.

A first pairwise distance may be determined (block 706). The server 110 may determine a first pairwise distance. The user device 100 may determine a first pairwise distance. The first pairwise distance may be determined based on a comparison of the first image and the second image. The first pairwise distance may be indicative of a similarity of the first image and the second image. A second pairwise distance may be determined. The server 110 may determine a second pairwise distance. The user device 100 may determine a second pairwise distance. The second pairwise distance may be determined based on a comparison of the first image and the third image. The second pairwise distance may be indicative of a similarity of the first image and the third image. A third pairwise distance may be determined. The server 110 may determine a third pairwise distance. The user device 100 may determine a third pairwise distance. The third pairwise distance may be determined based on a comparison of the second image and the third image. The third pairwise distance may be indicative of a similarity of the second image and the third image.

A variability metric may be determined (block 708). The server 110 may determine a variability metric. The user device 100 may determine a variability metric. The variability metric may be determined based at least on the first pairwise distance. The variability metric may be indicative of a human-readable characterization of the variability of the first image and the second image. The variability metric may be determined based at least on the second pairwise distance and the third pairwise distance. The variability metric may be indicative of a human-readable characterization of the variability among the first image, the second image, and the third image.

The determining the variability metric may comprise inputting the first pairwise distance into a normalization function to receive a normalized pairwise distance adapted to a target scale. The target scale may be zero to a hundred. The target scale may be zero to one.

A classification to the variability of the first image and the second image may be applied based on the variability metric. The classification may be one of: high, medium, low, or none.

Although example blocks are shown, some implementations may include additional blocks, fewer blocks, different blocks, or differently arranged blocks than those depicted. Additionally, or alternatively, two or more of the blocks may be performed in parallel.

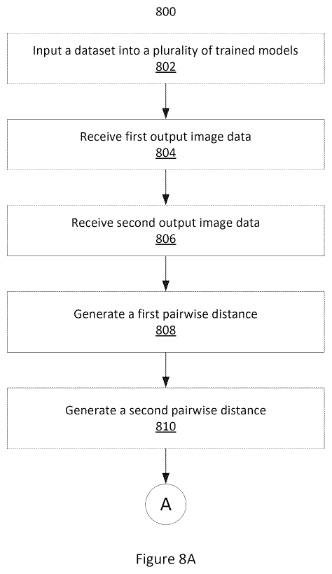

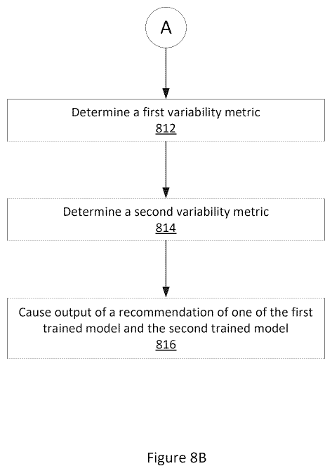

FIGS. 8A and 8B show a flowchart of an example process 800. In some implementations, one or more process blocks of FIG. 8 may be performed by the server 110 in FIG. 1 and/or the user device 100 in FIG. 1.

A dataset may be inputted into a plurality of trained models (block 802). The server 110 may input a dataset into a plurality of trained models. The user device 100 may input a dataset into a plurality of trained models. The dataset may comprise a plurality of text prompts. The trained models may be trained to produce an image based on an input text prompt.

First output image data may be received (block 804). The server 110 may receive first output image data. The user device 100 may receive first output image data. The first output image data may be based on the dataset. The first output image data may be received from a first trained model of the plurality of trained models. The first output image data may comprise at least a first image generated by the first trained model based on a first text prompt of the plurality of text prompts. The first output image data may comprise at least a second image generated by the first trained model based on the first text prompt. The first output image data may comprise at least a fifth image generated by the first trained model based on a second text prompt of the plurality of text prompts. The first output image data may comprise at least a sixth image generated by the first trained model based on the second text prompt.

Second output image data may be received (block 806). The server 110 may receive second output image data. The user device 100 may receive second output image data. The second output image data may be based on the dataset. The second output image data may be received from a second trained model of the plurality of trained models. The second output image data may comprise at least a third image generated by the second trained model based on the first text prompt. The second output image data may comprise at least a fourth image generated by the second trained model based on the first text prompt. The second output image data may comprise at least a seventh image generated by the second trained model based on the second text prompt. The second output image data may comprise at least an eighth image generated by the second trained model based on the second text prompt.

A first pairwise distance may be generated (block 808). The server 110 may generate a first pairwise distance. The user device 100 may generate a first pairwise distance. The first pairwise distance may be based on a comparison of the first image with the second image. The first pairwise distance may be indicative of a similarity of the first image and the second image.

A second pairwise distance may be generated (block 810). The server 110 may generate a second pairwise distance. The user device 100 may generate a second pairwise distance. The second pairwise distance may be based on a comparison of the third image with the fourth image. The second pairwise distance may be indicative of a similarity of the third image and the fourth image.

A third pairwise distance may be generated. The server 110 may generate a third pairwise distance. The user device 100 may generate a third pairwise distance. The third pairwise distance may be based on a comparison of the fifth image with the sixth image. The third pairwise distance may be indicative of a similarity of the fifth image and the sixth image.

A fourth pairwise distance may be generated. The server 110 may generate a fourth pairwise distance. The user device 100 may generate a fourth pairwise distance. The fourth pairwise distance may be based on a comparison of the seventh image with the eighth image. The fourth pairwise distance may be indicative of a similarity of the seventh image and the eighth image.

A first variability metric may be determined (block 812). The server 110 may determine a first variability metric. The user device 100 may determine a first variability metric. The first variability metric may be associated with the first trained model. The first variability metric may be based at least in part on the first pairwise distance. The determining the first variability metric associated with the first trained model may be further based at least in part on the third pairwise distance. The determining the first variability metric may further comprise inputting the first pairwise distance into a normalization function to receive a first normalized pairwise distance adapted to a target scale and inputting the second pairwise distance into the normalization function to receive a second normalized pairwise distance adapted to the target scale. The target scale may be zero to a hundred. The target scale may be zero to one.

A second variability metric may be determined (block 814). The server 110 may determine a second variability metric. The user device 100 may determine a second variability metric. The second variability metric may be associated with the second trained model. The second variability metric may be based at least in part on the second pairwise distance. The determining the second variability metric associated with the second trained model may be further based at least in part on the fourth pairwise distance. The determining the second variability metric may further comprise inputting the third pairwise distance into the normalization function to receive a third normalized pairwise distance adapted to the target scale and inputting the fourth pairwise distance into the normalization function to receive a fourth normalized pairwise distance adapted to the target scale.

Output of a recommendation of one of the first trained model and the second trained model may be caused (block 816). The server 110 may cause output of a recommendation of one of the first trained model and the second trained model. The user device 100 may cause output of a recommendation of one of the first trained model and the second trained model. The recommendation may be based at least on the first variability metric and the second variability metric.

A first classification may be applied to the first variability metric. The server 110 may apply a first classification to the first variability metric. The user device 100 may apply a first classification to the first variability metric. A second classification may be applied to the second variability metric. The server 110 may apply a second classification to the second variability metric. The user device 100 may apply a second classification to the second variability metric. The first classification and the second classification may be selected from: high, medium, low, or none.

Although example blocks are shown, some implementations may include additional blocks, fewer blocks, different blocks, or differently arranged blocks than those depicted. Additionally, or alternatively, two or more of the blocks may be performed in parallel.

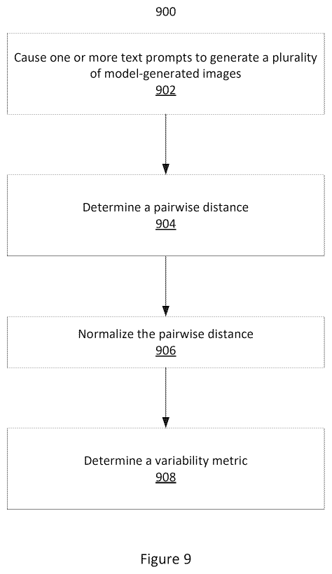

FIG. 9 shows a flowchart of an example process 900. In some implementations, one or more process blocks of FIG. 9 may be performed by the server 110 in FIG. 1 and/or the user device 100 in FIG. 1.

One or more text prompts may be caused to generate a plurality of model-generated images (block 902). The server 110 may cause one or more text prompts to generate a plurality of model-generated images. The user device 100 may cause one or more text prompts to generate a plurality of model-generated images. The plurality of model-generated images may be caused to be generated using a first model.

A pairwise distance may be determined (block 904). The server 110 may determine a pairwise distance. The user device 100 may determine a pairwise distance. The pairwise distance may be based on a second model and the plurality of model-generated images. The pairwise distance may comprise one or more pairs of images of the plurality of model-generated images. The pairwise distance may be indicative of a similarity of the one or more pairs of images.

The pairwise distance may be normalized (block 906). The server 110 may normalize the pairwise distance. The user device 100 may normalize the pairwise distance. The pairwise distance may be normalized based on a target scale. The pairwise distance may comprise the one or more pairs of images. Normalizing the pairwise distance may create a normalized pairwise distance of the one or more pairs of images. The target scale may be zero to a hundred. The target scale may be zero to a one.

A variability metric may be determined (block 908). The server 110 may determine a variability metric. The user device 100 may determine a variability metric. The variability metric may be determined based on at least the normalized pairwise distance. The variability metric may be indicative of a human-readable characterization of the variability of images of the one or more pairs of images.

Human feedback regarding the variability of images of the one or more pairs of images may be received. The server 110 may receive human feedback regarding the variability of images of the one or more pairs of images. The user device may receive human feedback regarding the variability of images of the one or more pairs of images. The variability metric may be verified based on the human feedback. The server 110 may verify the variability metric based on the human feedback. The user device 100 may verify the variability metric based on the human feedback.

A classification to the variability of images of the one or more pairs of images may be applied based on the variability metric. The server 110 may apply a classification to the variability of images of the one or more pairs of images based on the variability metric. The user device 100 may apply a classification to the variability of images of the one or more pairs of images based on the variability metric. The classification may be one of: high, medium, low, or none.

Although example blocks are shown, some implementations may include additional blocks, fewer blocks, different blocks, or differently arranged blocks than those depicted. Additionally, or alternatively, two or more of the blocks may be performed in parallel.

### Examples

Example Clause 1: A method may include: causing a first text prompt to be inputted into one or more first models to generate a first image; causing the first text prompt to be inputted into the one or more first models to generate a second image; determining, based on a comparison of the first image and the second image, a first pairwise distance indicative of a similarity of the first image and the second image; and determining, based at least on the first pairwise distance, a variability metric indicative of a human-readable characterization of the variability of the first image and the second image.

Example Clause 2: The method of Example Clause 1, further may include: causing the first text prompt to be inputted into the one or more first models to generate a third image; determining, based on a comparison of the first image and the third image, a second pairwise distance indicative of a similarity of the first image and the third image; determining, based on a comparison of the second image and the third image, a third pairwise distance indicative of a similarity of the second image and the third image; and determining, based at least on the second pairwise distance and the third pairwise distance, the variability metric, where the variability metric is indicative of a human-readable characterization of the variability among the first image, the second image, and the third image.

Example Clause 3: The method of Example Clause 1 or Example Clause 2, where the determining the variability metric further may include inputting the first pairwise distance into a normalization function to receive a normalized pairwise distance adapted to a target scale.

Example Clause 4: The method of any one of Example Clauses 1-3, where the target scale is zero to a hundred.

Example Clause 5: The method of any one of Example Clauses 1-4, where the target scale is zero to one.

Example Clause 6: The method of any one of Example Clauses 1-5, further may include applying a classification to the variability of the first image and the second image based on the variability metric.

Example Clause 7: The method of any one of Example Clauses 1-6, where the classification is one of: high, medium, low, or none.

Example Clause 8: A method may include: inputting a dataset into a plurality of trained models, where the dataset may include a plurality of text prompts, and where the trained models are trained to produce an image based on an input text prompt; receiving first output image data based on the dataset from a first trained model of the plurality of trained models, where the first output image data may include at least a first image generated by the first trained model based on a first text prompt of the plurality of text prompts, where the first output image data may include at least a second image generated by the first trained model based on the first text prompt; receiving second output image data based on the dataset from a second trained model of the plurality of trained models, where the second output image data may include at least a third image generated by the second trained model based on the first text prompt, where the second output image data may include at least a fourth image generated by the second trained model based on the first text prompt; generating, based on a comparison of the first image with the second image, a first pairwise distance indicative of a similarity of the first image and the second image; generating, based on a comparison of the third image with the fourth image, a second pairwise distance indicative of a similarity of the third image and the fourth image; determining a first variability metric associated with the first trained model based at least in part on the first pairwise distance; determining a second variability metric associated with the second trained model based at least in part on the second pairwise distance; and causing output of a recommendation of one of the first trained model and the second trained model based at least on the first variability metric and the second variability metric.

Example Clause 9: The method of Example Clause 8, further may include applying a first classification to the first variability metric.

Example Clause 10: The method of Example Clause 8 or Example Clause 9, further may include applying a second classification to the second variability metric.

Example Clause 11: The method of any one of Example Clauses 8-10, where the first classification and the second classification are selected from: high, medium, low, or none.

Example Clause 12: The method of any one of Example Clauses 8-11, where the first output image data may include at least a fifth image generated by the first trained model based on a second text prompt of the plurality of text prompts, where the first output image data may include at least a sixth image generated by the first trained model based on the second text prompt, where the second output image data may include at least a seventh image generated by the second trained model based on the second text prompt, and where the second output image data may include at least an eighth image generated by the second trained model based on the second text prompt.

Example Clause 13: The method of any one of Example Clauses 8-12, further may include: generating, based on a comparison of the fifth image with the sixth image, a third pairwise distance indicative of a similarity of the fifth image and the sixth image; and generating, based on a comparison of the seventh image with the eighth image, a fourth pairwise distance indicative of a similarity of the seventh image and the eighth image.

Example Clause 14: The method of any one of Example Clauses 8-13, where the determining the first variability metric associated with the first trained model is further based at least in part on the third pairwise distance.

Example Clause 15: The method of any one of Example Clauses 8-14, where the determining the second variability metric associated with the second trained model is further based at least in part on the fourth pairwise distance.

Example Clause 16: The method of any one of Example Clauses 8-15, where the determining the first variability metric further may include inputting the first pairwise distance into a normalization function to receive a first normalized pairwise distance adapted to a target scale and inputting the second pairwise distance into the normalization function to receive a second normalized pairwise distance adapted to the target scale.

Example Clause 17: The method of any one of Example Clauses 8-16, where the determining the second variability metric further may include inputting the third pairwise distance into the normalization function to receive a third normalized pairwise distance adapted to the target scale and inputting the fourth pairwise distance into the normalization function to receive a fourth normalized pairwise distance adapted to the target scale.

Example Clause 18: The method of any one of Example Clauses 8-17, where the target scale is zero to a hundred.

Example Clause 19: The method of any one of Example Clauses 8-18, where the target scale is zero to one.

Example Clause 20: A method may include: causing, using a first model, one or more text prompts to generate a plurality of model-generated images; determining, based on a second model and the plurality of model-generated images, a pairwise distance of one or more pairs of images of the plurality of model-generated images, where the pairwise distance is indicative of a similarity of the one or more pairs of images; normalizing, based on a target scale, the pairwise distance of the one or more pairs of images to create a normalized pairwise distance of the one or more pairs of images; and determining, based at least on the normalized pairwise distance, a variability metric indicative of a human-readable characterization of the variability of images of the one or more pairs of images.

Example Clause 21: The method of Example Clause 20, where the target scale is zero to a hundred.

Example Clause 22: The method of Example Clause 20 or Example Clause 21, where the target scale is zero to one.

Example Clause 23: The method of any one of Example Clauses 20-22, further may include: receiving human feedback regarding the variability of images of the one or more pairs of images; and verifying, based on the human feedback, the variability metric.

Example Clause 24: The method of any one of Example Clauses 20-23, further may include applying a classification to the variability of images of the one or more pairs of images based on the variability metric.

Example Clause 25: The method of any one of Example Clauses 20-24, where the classification is one of: high, medium, low, or none.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method comprising:
causing a first text prompt to be inputted into one or more first models to generate a first image;
causing the first text prompt to be inputted into the one or more first models to generate a second image;
determining, based on a comparison of the first image and the second image, a first pairwise distance indicative of a similarity of the first image and the second image; and
determining, based at least on the first pairwise distance, a variability metric indicative of a human-readable characterization of the variability of the first image and the second image.

2. The method of claim 1, further comprising:
causing the first text prompt to be inputted into the one or more first models to generate a third image;
determining, based on a comparison of the first image and the third image, a second pairwise distance indicative of a similarity of the first image and the third image;
determining, based on a comparison of the second image and the third image, a third pairwise distance indicative of a similarity of the second image and the third image; and
determining, based at least on the second pairwise distance and the third pairwise distance, the variability metric, wherein the variability metric is indicative of a human-readable characterization of the variability among the first image, the second image, and the third image.

3. The method of claim 1, wherein the determining the variability metric further comprises inputting the first pairwise distance into a normalization function to receive a normalized pairwise distance adapted to a target scale.

4. The method of claim 3, wherein the target scale is zero to a hundred.

5. The method of claim 3, wherein the target scale is zero to one.

6. The method of claim 1, further comprising applying a classification to the variability of the first image and the second image based on the variability metric.

7. The method of claim 6, wherein the classification is one of: high, medium, low, or none.

8. A method comprising:
inputting a dataset into a plurality of trained models, wherein the dataset comprises a plurality of text prompts, and wherein the trained models are trained to produce an image based on an input text prompt;
receiving first output image data based on the dataset from a first trained model of the plurality of trained models, wherein the first output image data comprises at least a first image generated by the first trained model based on a first text prompt of the plurality of text prompts, wherein the first output image data comprises at least a second image generated by the first trained model based on the first text prompt;
receiving second output image data based on the dataset from a second trained model of the plurality of trained models, wherein the second output image data comprises at least a third image generated by the second trained model based on the first text prompt, wherein the second output image data comprises at least a fourth image generated by the second trained model based on the first text prompt;
generating, based on a comparison of the first image with the second image, a first pairwise distance indicative of a similarity of the first image and the second image;
generating, based on a comparison of the third image with the fourth image, a second pairwise distance indicative of a similarity of the third image and the fourth image;
determining a first variability metric associated with the first trained model based at least in part on the first pairwise distance;
determining a second variability metric associated with the second trained model based at least in part on the second pairwise distance; and
causing output of a recommendation of one of the first trained model and the second trained model based at least on the first variability metric and the second variability metric.

9. The method of claim 8, further comprising applying a first classification to the first variability metric.

10. The method of claim 9, further comprising applying a second classification to the second variability metric.

11. The method of claim 10, wherein the first classification and the second classification are selected from: high, medium, low, or none.

12. The method of claim 8, wherein the first output image data comprises at least a fifth image generated by the first trained model based on a second text prompt of the plurality of text prompts, wherein the first output image data comprises at least a sixth image generated by the first trained model based on the second text prompt, wherein the second output image data comprises at least a seventh image generated by the second trained model based on the second text prompt, and wherein the second output image data comprises at least an eighth image generated by the second trained model based on the second text prompt.

13. The method of claim 12, further comprising:
generating, based on a comparison of the fifth image with the sixth image, a third pairwise distance indicative of a similarity of the fifth image and the sixth image; and
generating, based on a comparison of the seventh image with the eighth image, a fourth pairwise distance indicative of a similarity of the seventh image and the eighth image.

14. The method of claim 13, wherein the determining the first variability metric associated with the first trained model is further based at least in part on the third pairwise distance.

15. The method of claim 14, wherein the determining the second variability metric associated with the second trained model is further based at least in part on the fourth pairwise distance.

16. The method of claim 15, wherein the determining the first variability metric further comprises inputting the first pairwise distance into a normalization function to receive a first normalized pairwise distance adapted to a target scale and inputting the second pairwise distance into the normalization function to receive a second normalized pairwise distance adapted to the target scale.

17. The method of claim 16, wherein the determining the second variability metric further comprises inputting the third pairwise distance into the normalization function to receive a third normalized pairwise distance adapted to the target scale and inputting the fourth pairwise distance into the normalization function to receive a fourth normalized pairwise distance adapted to the target scale.

18. The method of claim 17, wherein the target scale is zero to a hundred.

19. The method of claim 17, wherein the target scale is zero to one.

20. A method comprising:
causing, using a first model, one or more text prompts to generate a plurality of model-generated images;
determining, based on a second model and the plurality of model-generated images, a pairwise distance of one or more pairs of images of the plurality of model-generated images, wherein the pairwise distance is indicative of a similarity of the one or more pairs of images;
normalizing, based on a target scale, the pairwise distance of the one or more pairs of images to create a normalized pairwise distance of the one or more pairs of images; and
determining, based at least on the normalized pairwise distance, a variability metric indicative of a human-readable characterization of the variability of images of the one or more pairs of images.

21. The method of claim 20, wherein the target scale is zero to a hundred.

22. The method of claim 20, wherein the target scale is zero to one.

23. The method of claim 20, further comprising applying a classification to the variability of images of the one or more pairs of images based on the variability metric.

24. The method of claim 23, wherein the classification is one of: high, medium, low, or none.
